(19) United States
(12) Patent Application Publication
(10) Pub. No.: US 2011/0222592 A1
(43) Pub. Date: Sep. 15, 2011

(54) MEASUREMENT APPARATUS, MEASUREMENT METHOD AND RECORDING MEDIUM

(75) Inventor: Koji ASAMI, Saitama (JP)

(73) Assignee: ADVANTEST CORPORATION, Tokyo (JP)

(21) Appl. No.: 13/019,257

(22) Filed: Feb. 1, 2011

(30) Foreign Application Priority Data
Mar. 11, 2010 (JP) 2010-054486

(51) Int. Cl. H04B 17/00

(52) U.S. Cl. 375/226

(57) ABSTRACT

A measurement apparatus that measures at least one of phase error and gain error between I and Q of a quadrature modulator, comprising a supplying section that shifts a reference I signal corresponding to an I component in an IQ signal causing a tone signal and/or a reference Q signal corresponding to a Q component in the IQ signal to have a time difference therebetween, and supplies the resulting signals to the quadrature modulator; and a calculating section that calculates at least one of the phase error and the gain error, based on an I-signal frequency component corresponding to a tone signal in a modulated signal output from the quadrature modulator in response to the reference I signal being supplied thereto and a Q-signal frequency component corresponding to a tone signal in a modulated signal output from the quadrature modulator in response to the reference Q signal being supplied thereto.

### BACKGROUND

1. Technical Field

The present invention relates to a measurement apparatus, a measurement method, and a recording medium.

2. Related Art

A digital wireless communication device includes a quadrature modulator and a quadrature demodulator. The quadrature modulator and the quadrature demodulator have a carrier phase error and an IQ error, which is a gain error and a phase error between the I-signal path and the Q-signal path. These errors have a significant impact on the quality of the quadrature modulator and the quadrature demodulator. Therefore, manufacturers of quadrature modulators and quadrature demodulators measure the IQ errors and carrier phase errors at the time of shipping, in order to judge pass/fail and make repairs.

Patent Document 1 discloses a measurement apparatus that supplies a quadrature modulator with sinusoidal waves having phases differing from each other by 90 degrees, and calculates the carrier phase error, the gain error, and the skew based on a primary signal component and an image signal component in the modulated signal output by the quadrature modulator. Patent Document 2 discloses a measurement apparatus that causes signals to be transmitted from subcarriers to measure skew and carrier frequency phase error between a plurality of transmitters that transmit data signals in parallel. Patent Document 3 discloses a measurement apparatus that measures the phase errors of signals modulated with different frequencies.
Patent Document 1: International Publication WO 2008/047684
Patent Document 2: International Publication WO 2007/072653
Patent Document 3: International Publication WO 2007/077686

A conventional measurement apparatus cannot easily and accurately measure the IQ error in a quadrature modulator and a quadrature demodulator for each cause of the IQ error. For example, a conventional measurement apparatus cannot easily and accurately measure the gain error and the phase error separately.

Furthermore, mismatched filter characteristics between the I-signal path and the Q-signal path in the quadrature modulator or the quadrature demodulator cause the IQ error to have a frequency dependence. It is difficult for a conventional measurement apparatus to accurately measure frequency-dependent IQ errors.

### SUMMARY

Therefore, it is an object of an aspect of the innovations herein to provide a measurement apparatus, a measurement method, and a recording medium storing thereon a program, which are capable of overcoming the above drawbacks accompanying the related art. The above and other objects can be achieved by combinations described in the independent claims. According to a first aspect related to the innovations herein, provided is a measurement apparatus that measures at least one of phase error and gain error between I and Q of a quadrature modulator. The measurement apparatus comprises a supplying section that shifts a reference I signal corresponding to an I component in an IQ signal causing a tone signal and/or a reference Q signal corresponding to a Q component in the IQ signal to have a time difference therebetween, and supplies the resulting signals to the quadrature modulator; and a calculating section that calculates at least one of the phase error and the gain error, based on an I-signal frequency component corresponding to a tone signal in a modulated signal output from the quadrature modulator in response to the reference I signal being supplied thereto and a Q-signal frequency component corresponding to a tone signal in a modulated signal output from the quadrature modulator in response to the reference Q signal being supplied thereto. Also provided is a measurement method relating to the measurement apparatus and a recording medium storing thereon a program.

The summary clause does not necessarily describe all necessary features of the embodiments of the present invention. The present invention may also be a sub-combination of the features described above.

### BRIEF DESCRIPTION OF THE DRAWINGS

FIG. 1 shows the configuration of a measurement apparatus 10 according to an embodiment of the present invention, together with a quadrature modulator 200.

FIG. 2 shows an exemplary multi-tone signal output from an ideal quadrature modulator when the quadrature modulator is simultaneously supplied with a reference I signal and a reference Q signal.

FIG. 3 shows exemplary timings at which the reference I signal and the reference Q signal are supplied to the quadrature modulator 200 after at least one of the reference I signal and reference Q signal is shifted to create a time difference therebetween.

FIG. 4 shows an error model of the quadrature modulator 200.

FIG. 5 shows exemplary frequency characteristics of the IQ error.

FIG. 6 shows a first exemplary process flow of the calculating section 22 according to the present embodiment.

FIG. 7 shows a second exemplary process flow of the calculating section 22 according to the present embodiment.

FIG. 8 shows a third exemplary process flow of the calculating section 22 according to the present embodiment.

FIG. 9 shows an exemplary multi-tone signal output from an ideal quadrature modulator simultaneously supplied with a reference I signal and a reference Q signal.

FIG. 10 shows a configuration of the measurement apparatus 10 according to a first modification of the present embodiment, along with the quadrature modulator 200.

FIG. 11 shows an exemplary multi-tone signal of a measurement apparatus 10 according to a second modification of the present embodiment, output by an ideal quadrature modulator supplied with a reference I signal and a reference Q signal.

FIG. 12 shows an exemplary configuration of the measurement apparatus 10 according to a third modification of the present embodiment, along with the quadrature demodulator 300.

FIG. 13 shows an example of a hardware configuration of a computer 1900 according to the present embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

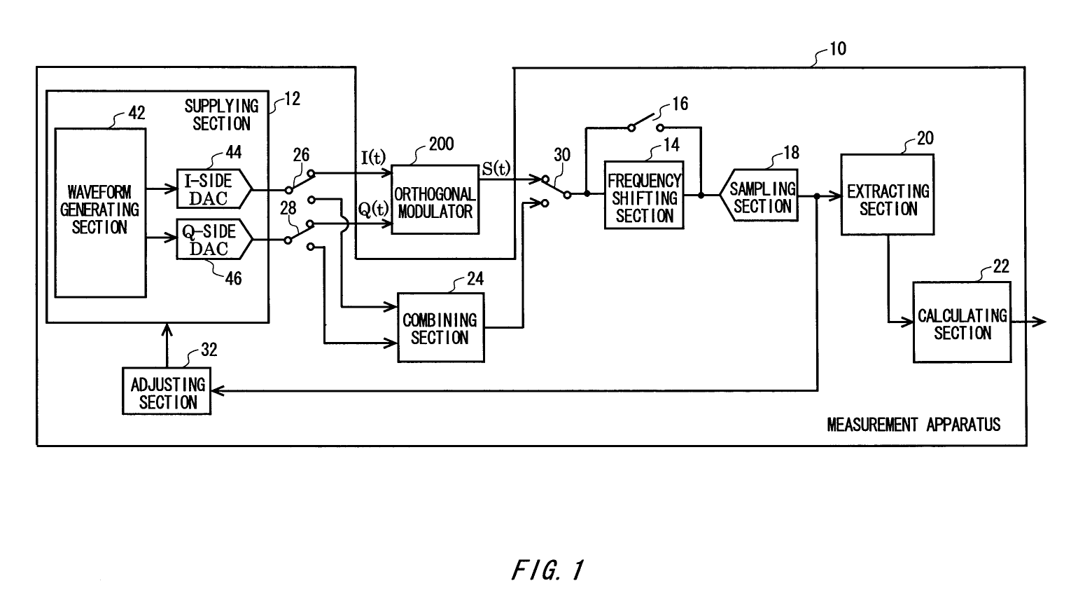

FIG. 1 shows the configuration of a measurement apparatus 10 according to an embodiment of the present invention, together with a quadrature modulator 200. The measurement apparatus 10 measures at least one of the phase error and the gain error between I and Q of the quadrature modulator 200.

The measurement apparatus 10 includes a supplying section 12, a frequency shifting section 14, a bypass switch 16, a sampling section 18, an extracting section 20, a calculating section 22, a combining section 24, an I-side output switching section 26, an I-side output switching section 28, an input switching section 30, and an adjusting section 32.

The supplying section 12 shifts a reference I signal corresponding to an I component of an IQ signal causing a tone signal and/or a reference Q signal corresponding to a Q component of this IQ signal to create a time difference therebetween, and supplies the resulting I signal and Q signal to the quadrature modulator 200. In this case, the supplying section 12 supplies the reference I signal to an I-signal input port of the quadrature modulator 200 and supplies the reference Q signal to a Q-signal input port of the quadrature modulator 200.

In the present embodiment, the supplying section 12 shifts a reference I signal and/or a reference Q signal corresponding to an IQ signal causing a multi-tone signal with either a positive frequency or a negative frequency to have a time difference therebetween, and supplies the resulting signals to the quadrature modulator 200. The multi-tone signal refers to a modulated signal that includes tone signals with a plurality of frequencies ω₁, ω₂, ω₃, . . . , ωₖ, where k is a natural number. Instead, the supplying section 12 may supply the quadrature modulator 200 with a reference I signal and a reference Q signal corresponding to an IQ signal that causes a monotone signal, i.e. a modulated signal including a tone signal with only one frequency. Furthermore, positive frequency refers to a frequency that is higher than the carrier frequency of the modulated signal and negative frequency refers to a frequency that is lower than the carrier frequency of the modulated signal.

The supplying section 12 may include a waveform generating section 42, an I-side DAC 44, and a Q-side DAC 46. The waveform generating section 42 generates the waveform data of the reference I signal and the waveform data of the reference Q signal with a time difference therebetween.

The waveform generating section 42 may output, as the waveform data of the reference I signal, data indicating a waveform obtained as the total of sinusoidal waves having predetermined frequencies and predetermined phases, e.g. cosine waves. The waveform generating section 42 may output, as the waveform data of the reference Q signal, data indicating a waveform obtained as the total of sinusoidal waves with phases differing by 90 degrees from the reference I signal, e.g. sine waves.

The waveform generating section 42 supplies the waveform data of the reference I signal described above to the I-side DAC 44. The waveform generating section 42 supplies the waveform data of the reference Q signal described above to the Q-side DAC 46.

The I-side DAC 44 performs DA conversion on the waveform data of the reference I signal supplied from the waveform generating section 42, and supplies the result to the I-signal input terminal of the quadrature modulator 200. The Q-side DAC 46 performs DA conversion of the waveform data of the reference Q signal supplied from the waveform generating section 42, and supplies the result to the Q-signal input terminal of the quadrature modulator 200.

In the manner described above, the supplying section 12 can shift the reference I signal and/or the reference Q signal to have a time difference therebetween, and supply the resulting signals to the quadrature modulator 200. In response to the reference I signal being supplied thereto, the quadrature modulator 200 can output a modulated signal obtained by modulating the reference I signal with the I component of the carrier signal and modulating a zero-amplitude Q signal by the Q component of the carrier signal. Furthermore, in response to the reference Q signal being supplied thereto, the quadrature modulator 200 can output a modulated signal obtained by modulating a zero-amplitude I signal by the I component of the carrier signal and modulating the reference Q signal by the Q component of the carrier signal.

The frequency shifting section 14 down-converts the carrier frequency of the modulated signal output by the quadrature modulator 200 to an intermediate frequency, and supplies the resulting signal to the sampling section 18. If the down conversion by the frequency shifting section 14 is unnecessary, the bypass switch 16 causes the modulated signal output from the quadrature modulator 200 to bypass the frequency shifting section 14 and be supplied to the sampling section 18.

The sampling section 18 samples and digitizes the modulated signal output from the frequency shifting section 14. If the down conversion by the frequency shifting section 14 is unnecessary, the sampling section 18 directly samples and digitizes the modulated signal output from the quadrature modulator 200.

The extracting section 20 extracts the frequency component, i.e. the I-signal frequency component, corresponding to each tone signal included in the modulated signal output from the quadrature modulator 200 in response to the reference I signal supplied thereto. The extracting section 20 extracts the frequency component, i.e. the Q-signal frequency component, corresponding to each tone signal included in the modulated signal output from the quadrature modulator 200 in response to the reference Q signal supplied thereto. The extracting section 20 may extract the I-signal frequency component and the Q-signal frequency component, which are the frequency components corresponding to a tone signal, by performing a discrete Fourier transform, such as a fast Fourier transform, on the modulated signal digitized by the sampling section 18.

Here, the extracting section 20 extracts, as the frequency components corresponding to each tone signal, a signal component with the frequency of the tone signal and a signal component with a frequency positioned in a manner to sandwich the carrier frequency ω₀ with the frequency of the tone signal and to have the opposite sign of the frequency of the tone signal. If the frequency of the tone signal is ωₖ and the carrier frequency is ω₀, for example, the extracting section 20 extracts a signal component with a frequency ω₀+ωₖ and a signal component with a frequency ω₀-ωₖ.

The calculating section 22 calculates at least one of the phase error and the gain error of the quadrature modulator 200, based on the I-signal frequency component and the Q-signal frequency component extracted by the extracting section 20. The calculating section 22 may also calculate the carrier phase error of the quadrature modulator 200. The calculating section 22 may also measure the frequency characteristics of the phase error and of the gain error.

The extracting section 20 and calculating section 22 described above may be realized as a processor. The calculation method performed by the calculating section 22 is described in detail below.

At an adjustment time that is prior to the measurement of the IQ error, the combining section 24 combines an adjustment I signal and an adjustment Q signal output from the supplying section 12, and supplies the result to the sampling section 18.

The I-side output switching section 26 and the I-side output switching section 28 switch the destination of the signals from the supplying section 12 according to the adjustment time and an IQ error measurement time. During the measurement time, the I-side output switching section 26 and the I-side output switching section 28 supply the quadrature modulator 200 with the reference I signal and the reference Q signal output from the supplying section 12. During the adjustment time, the I-side output switching section 26 and the I-side output switching section 28 supply the combining section 24 with the adjustment I signal and the adjustment Q signal output from the supplying section 12.

The input switching section 30 switches the input destination of the signal sampled by the sampling section 18 according to the IQ error measurement time and the adjustment time. During the measurement time, the input switching section 30 causes the modulated signal output from the quadrature modulator 200 to be sampled by the sampling section 18. During the adjustment time, the input switching section 30 causes the combined signal output from the combining section 24 to be sampled by the sampling section 18.

The adjusting section 32 adjusts the error, e.g. the frequency error, phase error, or gain error, of the reference I signal and the reference Q signal output by the supplying section 12. For example, the adjusting section 32 causes the supplying section 12 to output a predetermined adjustment I signal and a predetermined adjustment Q signal to be sampled by the sampling section 18. The adjusting section 32 adjusts the reference I signal and the reference Q signal output by the supplying section 12, based on the sampling results. For example, the adjusting section 32 may adjust the error between the reference I signal and the reference Q signal output by the supplying section 12 using the methods described in Patent Document 2 and Patent Document 3.

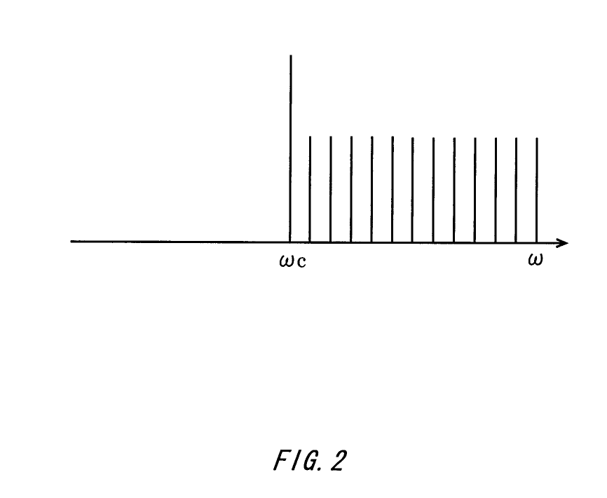

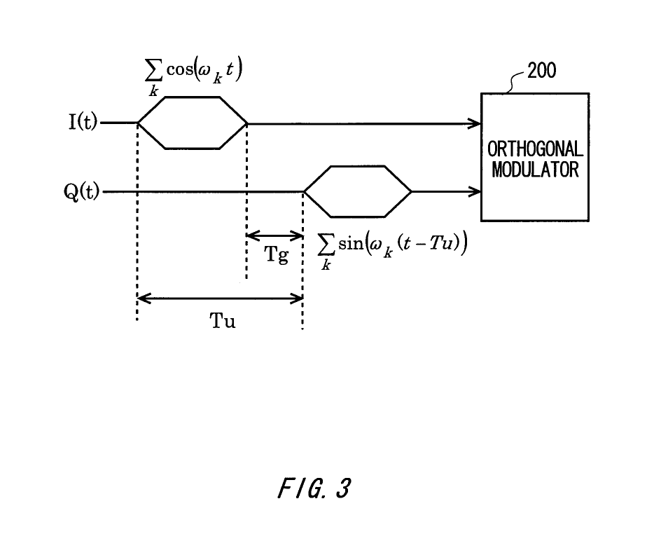

FIG. 2 shows an exemplary multi-tone signal output from an ideal quadrature modulator when the quadrature modulator is simultaneously supplied with a reference I signal and a reference Q signal. FIG. 3 shows exemplary timings at which the reference I signal and the reference Q signal are supplied to the quadrature modulator 200.

The supplying section 12 of the measurement apparatus 10 outputs the reference I signal and the reference Q signal causing a multi-tone signal such as shown in FIG. 2. The supplying section 12 temporally shifts the waveform of the reference I signal and/or the waveform of the reference Q signal as shown in FIG. 3, such that these waveforms do not overlap, and supplies the quadrature modulator 200 with the resulting waveforms.

The supplying section 12 may shift the reference I signal and/or the reference Q signal to have a difference therebetween of a period Tu, which is longer then the time width of the waveform of the reference I signal (or the waveform of the reference Q signal), and supply resulting signals to the quadrature modulator 200. If a filter or the like is provided downstream from the quadrature modulator 200, the modulated signal output by the quadrature modulator 200 has a waveform that expands due to distortion or the like. Accordingly, the supplying section 12 preferably ensures a predetermined guard period Tg between the reference I signal and the reference Q signal.

The supplying section 12 preferably supplies the quadrature modulator 200 with the reference I signal and the reference Q signal in a continuous serious without stopping the clock. As a result, the measurement apparatus 10 can accurately extract the frequency characteristics of the reference I signal and the reference Q signal without correcting phase skew of the sampling clocks.

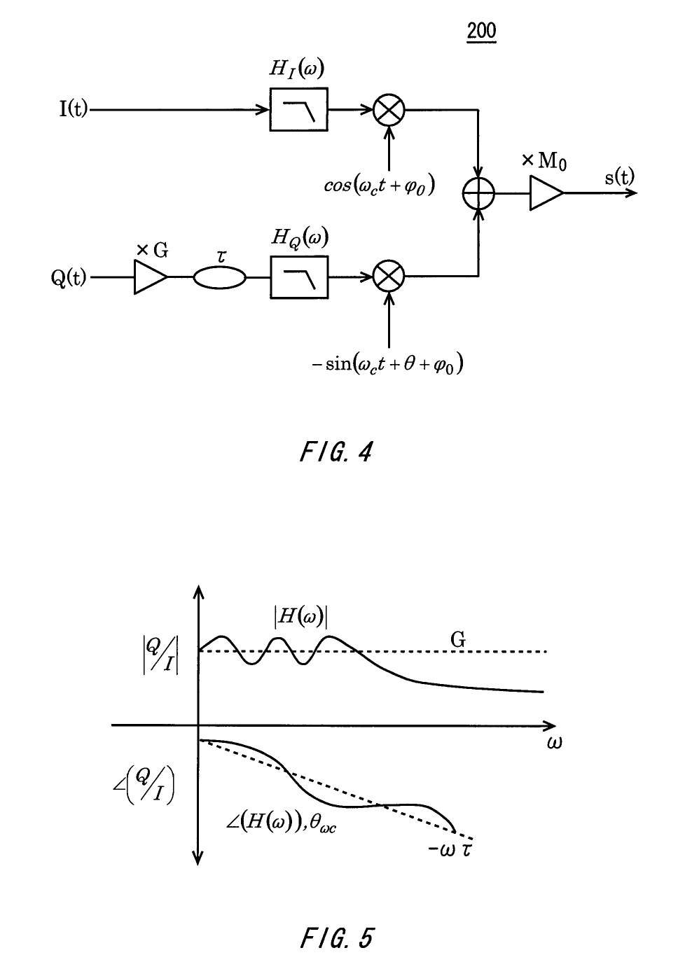

FIG. 4 shows an error model of the quadrature modulator 200. The following describes the error model of the quadrature modulator 200. The variables used in the description of the error model are shown below.

t represents time.
ω_{C} represents the carrier frequency.
ω₀ represents the angular frequency of the signal input to the quadrature modulator 200.
I(t) represents the time waveform of the I signal input to the quadrature modulator 200.
Q(t) represents the time waveform of the Q signal input to the quadrature modulator 200.
s(t) represents the time waveform of the modulated signal output from the quadrature modulator 200.
H_{I}(ω) represents the filter characteristic of the I-signal path of the quadrature modulator 200 with respect to angular frequency ω.
H_{Q}(ω) represents the filter characteristic of the Q-signal path of the quadrature modulator
200 with respect to angular frequency ω.
M₀ represents the gain of the quadrature modulator 200.
G represents the gain error between I and Q of the quadrature modulator 200.
τ represents the skew between I and Q of the quadrature modulator 200.
θ and θω_{C} represent carrier phase errors of the quadrature modulator 200.
φ represents the initial phase of the carrier signal.

In the error model of FIG. 4, when H_{I}(ω), H_{Q}(ω), and τ are not considered, the modulated signal s(t) output from the quadrature modulator 200 is expressed as shown in Expression 1 below.

$$\begin{matrix}s ( t ) = {M}_{0} \cdot \{ I ( t ) \cdot cos ( {ω}_{c} t + {ϕ}_{0} ) - G \cdot Q ( t ) \cdot sin ( {ω}_{c} t + {ϕ}_{0} + θ ) \} \\ = {M}_{0} \cdot \{ \begin{matrix}( I ( t ) - Q ( t ) \cdot G \cdot sin ( θ ) ) \cdot cos ( {ω}_{c} t + {ϕ}_{0} ) - \\ Q ( t ) \cdot G \cdot cos ( θ ) \cdot sin ( {ω}_{c} t + {ϕ}_{0} )\end{matrix} \}\end{matrix} \qquad ( 1 )$$

When this modulated signal S(t) is demodulated by an ideal quadrature demodulator, the demodulated baseband signal R(t) is expressed as shown in Expression 2 below. The carrier phase error θ and the gain error G between I and Q are considered as being included on the Q-signal side.

$$\begin{matrix}\overline{R} ( t ) = \frac{{M}_{0} \cdot {e}^{{jϕ}_{0}}}{2} \cdot \{ ( I ( t ) - Q ( t ) \cdot G \cdot sin ( θ ) ) + j \cdot Q ( t ) \cdot G \cdot cos ( θ ) \} \\ = \frac{{M}_{0} \cdot {e}^{{jϕ}_{0}}}{2} \cdot \{ I ( t ) + j \cdot Q ( t ) \cdot G \cdot ( cos ( θ ) + j \cdot sin ( θ ) ) \} \\ = \frac{{M}_{0} \cdot {e}^{{jϕ}_{0}}}{2} \cdot \{ I ( t ) + j \cdot Q ( t ) \cdot G \cdot {e}^{jθ} \}\end{matrix} \qquad ( 2 )$$

Next, it is assumed that the quadrature modulator 200 with a skew τ between I and Q is supplied with the reference I signal and the reference Q signal having angular frequencies of ω₀. The skew between I and Q is considered as being included on the Q-signal side.

In this case, the baseband signal demodulated by the ideal quadrature demodulator can be calculated by substituting cos(ω₀t) for I(t) and sin( 7₀(t−τ)) for Q(t) in Expression 2. The result of this is shown below in Expression 3.

$$\frac{{M}_{0} \cdot {e}^{{jϕ}_{0}}}{2} \cdot \{ I ( t ) + j \cdot Q ( t ) \cdot G \cdot {e}^{j θ} \} = \frac{{M}_{0} \cdot {e}^{{jϕ}_{0}}}{2} \cdot \{ \begin{matrix}\frac{{e}^{{jω}_{0} t} + {e}^{- {jω}_{0} t}}{2} + \\ j \cdot \frac{{e}^{{jω}_{0} ( t - τ )} - {e}^{- {jω}_{0} ( t - τ )}}{2 j} \cdot G \cdot {e}^{jθ}\end{matrix} \} = \frac{{M}_{0} \cdot {e}^{{jϕ}_{0}}}{2} \cdot \{ \begin{matrix}\frac{( 1 + G \cdot {e}^{jθ} \cdot {e}^{- {jω}_{0} τ} ) {e}^{{jω}_{0} t}}{2} + \\ \frac{( 1 - G \cdot {e}^{jθ} \cdot {e}^{{jω}_{0} τ} ) {e}^{- {jω}_{0} t}}{2}\end{matrix} \} = \frac{{M}_{0} \cdot {e}^{{jϕ}_{0}}}{4} \cdot \{ \begin{matrix}( 1 + G \cdot {e}^{jθ} \cdot {e}^{- {jω}_{0} τ} ) {e}^{{jω}_{0} t} + \\ ( 1 - G \cdot {e}^{jθ} \cdot {e}^{{jω}_{0} τ} ) {e}^{- {jω}_{0} t}\end{matrix} \} \qquad ( 3 )$$

It is further assumed that the filter characteristic of the I-signal path is H_{I}(ω₀) and the filter characteristic of the Q-signal path is H_{Q}(ω₀) in the quadrature modulator 200. In this case, the baseband signal demodulated by the ideal quadrature demodulator is expressed as shown in Expression 4 below.

$$\frac{{M}_{0} \cdot {e}^{{jϕ}_{0}}}{2} \cdot \{ I ( t ) + j \cdot Q ( t ) \cdot G \cdot {e}^{j θ} \} = \frac{{M}_{0} \cdot {e}^{{jϕ}_{0}}}{2} \cdot \{ \begin{matrix}\frac{{H}_{I} ( {ω}_{0} ) {e}^{{jω}_{0} t} + {H}_{I} ( - {ω}_{0} ) {e}^{- {jω}_{0} t}}{2} + \\ j \cdot \frac{{H}_{Q} ( {ω}_{0} ) {e}^{{jω}_{0} ( t - τ )} - {H}_{Q} ( - {ω}_{0} ) {e}^{- {jω}_{0} ( t - τ )}}{2 j} \cdot G \cdot {e}^{jθ}\end{matrix} \} = \frac{{M}_{0} \cdot {e}^{{jϕ}_{0}}}{4} \cdot \{ \begin{matrix}{H}_{I} ( {ω}_{0} ) ( 1 + \frac{{H}_{Q} ( {ω}_{0} )}{{H}_{I} ( {ω}_{0} )} G \cdot {e}^{jθ} \cdot {e}^{- {jω}_{0} τ} ) {e}^{{jω}_{0} t} + \\ {H}_{I} ( - {ω}_{0} ) ( 1 - \frac{{H}_{Q} ( - {ω}_{0} )}{{H}_{I} ( - {ω}_{0} )} G \cdot {e}^{jθ} \cdot {e}^{{jω}_{0} τ} ) {e}^{- {jω}_{0} t}\end{matrix} \} \qquad ( 4 )$$

In other words, Expression 4 represents the baseband signal demodulated by the ideal quadrature demodulator when the reference I signal and the reference Q signal having angular frequencies ω₀ are supplied to the quadrature modulator 200 in which the gain error between I and Q is G, the skew between I and Q is τ, the carrier phase error is θ, the filter characteristic of the I-signal path is H_{I}(ω₀) and the filter characteristic of the Q-signal path is H_{Q}(ω₀). Based on Expression 4, the frequency characteristic of the baseband signal included in the modulated signal s(t) output from the quadrature modulator 200 can be expressed as shown in Expression 5 below.

$$\{ \begin{matrix}A ( {ω}_{0} ) = \frac{{M}_{0} \cdot {e}^{{jϕ}_{0}}}{4} \cdot {H}_{I} ( {ω}_{0} ) ( 1 + H ( {ω}_{0} ) G \cdot {e}^{jθ ( ω )} \cdot {e}^{- {jω}_{0} τ} ) \\ B ( - {ω}_{0} ) = \frac{{M}_{0} \cdot {e}^{{jϕ}_{0}}}{4} \cdot {H}_{I} ( - {ω}_{0} ) ( 1 - H ( - {ω}_{0} ) G \cdot {e}^{jθ ( ω )} \cdot {e}^{{jω}_{0} τ} )\end{matrix} \qquad ( 5 )$$

In Expression 5, A(ω₀) represents the signal component having a positive frequency in the baseband signal, and B(−ω₀) represents the signal component having a negative frequency in the baseband signal. Furthermore, H(ω₀) represents the error in the filter characteristics between the I-signal path and the Q-signal path for the angular frequency ω₀, as shown in Expression 6 below.

$$H ( {ω}_{0} ) = \frac{{H}_{Q} ( {ω}_{0} )}{{H}_{I} ( {ω}_{0} )} \qquad ( 6 )$$

The following describes a method for calculating the frequency characteristic of the phase error, the frequency characteristic of the gain error, and the carrier phase error of the quadrature modulator 200.

The baseband signal demodulated by the quadrature demodulator from the modulated signal output by the quadrature modulator 200 supplied with only the reference I signal is expressed as shown below in Expression 7. The baseband signal demodulated by the quadrature demodulator from the modulated signal output by the quadrature modulator 200 supplied with only the reference Q signal is expressed as shown below in Expression 8.

$$\begin{matrix}\tilde{I} ( t ) = \frac{{M}_{0} \cdot {e}^{{jϕ}_{0}}}{4} \cdot ( {H}_{I} ( ω ) {e}^{jω t} + {H}_{I} ( - ω ) {e}^{- jω t} ) & ( 7 ) \\ j \tilde{Q} ( t ) = \frac{{M}_{0} \cdot {e}^{{jϕ}_{0}}}{4} \cdot ( {H}_{Q} ( ω ) {e}^{jω ( t - τ )} - {H}_{Q} ( - ω ) {e}^{- jω ( t - τ )} ) G \cdot {e}^{{jθω}_{c}} & ( 8 )\end{matrix}$$

Based on Expression 7, the I-signal frequency component corresponding to the tone signal, which is included in the modulated signal output from the quadrature modulator 200 supplied only with the reference I signal, is expressed as shown below in Expression 9. Here, AO)) represents the signal component having a positive frequency in the I-signal frequency component, and B_{I}(−ω) represents the signal component having a negative frequency in the I-signal frequency component.

$$\{ \begin{matrix}{A}_{I} ( ω ) = \frac{{M}_{0} \cdot {e}^{{jϕ}_{0}} {H}_{I} ( ω )}{4} \\ {B}_{I} ( - ω ) = \frac{{M}_{0} \cdot {e}^{{jϕ}_{0}} {H}_{I} ( - ω )}{4}\end{matrix} \qquad ( 9 )$$

In the same way, based on Expression 7, the Q-signal frequency component corresponding to the tone signal, which is included in the modulated signal output from the quadrature modulator 200 supplied only with the reference Q signal, is expressed as shown below in Expression 10. Here, A_{Q}(ω) represents the signal component having a positive frequency in the Q-signal frequency component, and B_{Q}(−ω) represents the signal component having a negative frequency in the Q-signal frequency component.

$$\{ \begin{matrix}j {A}_{Q} ( ω ) = \frac{{M}_{0} \cdot {e}^{{jϕ}_{0}}}{4} \cdot G \cdot {e}^{{jθω}_{c}} {H}_{Q} ( ω ) {e}^{- jωτ} \\ j {B}_{Q} ( - ω ) = \frac{{M}_{0} \cdot {e}^{{jϕ}_{0}}}{4} \cdot G \cdot {e}^{{jθω}_{c}} {H}_{Q} ( - ω ) {e}^{jωτ}\end{matrix} \qquad ( 10 )$$

The ratio P(ω) between the positive frequency component of the I-signal frequency component and the positive frequency component of the Q-signal frequency component is expressed as shown below in Expression 11.

$$\begin{matrix}P ( ω ) = \frac{j {A}_{Q} ( ω )}{{A}_{I} ( ω )} \\ = \frac{{H}_{Q} ( ω )}{{H}_{I} ( ω )} \cdot G \cdot {e}^{{jθω}_{c}} {e}^{- jωτ} \\ = \vert H ( ω ) \vert {e}^{- j ( ωτ - ∠ H ( ω ) )} \cdot G \cdot {e}^{{jθω}_{c}}\end{matrix} \qquad ( 11 )$$

The ratio N(−ω) between the negative frequency component of the I-signal frequency component and the negative frequency component of the Q-signal frequency component is expressed as shown below in Expression 12.

$$\begin{matrix}N ( - ω ) = \frac{j {B}_{Q} ( - ω )}{{B}_{I} ( - ω )} \\ = - \frac{{H}_{Q} ( - ω )}{{H}_{I} ( - ω )} \cdot G \cdot {e}^{{jθω}_{c}} {e}^{jωτ} \\ = - \vert H ( ω ) \vert {e}^{j ( ωτ - ∠ H ( ω ) )} \cdot G \cdot {e}^{{jθω}_{c}}\end{matrix} \qquad ( 12 )$$

Here, H(ω) is expressed as shown below in Expression 13.

$$H ( ω ) = \frac{{H}_{Q} ( ω )}{{H}_{I} ( ω )} \qquad ( 13 )$$

Based on Expressions 11, 12, and 13, −N(−ω)/P(ω) is expressed as shown below in Expression 14.

$$\frac{- N ( - ω )}{P ( ω )} = {e}^{2 j ( ωτ - ∠ H ( ω ) )} \qquad ( 14 )$$

Calculating half of the phase of Expression 14 leads to Expression 15 shown below.

$$\frac{1}{2} ( ∠ ( \frac{- N ( - ω )}{P ( ω )} ) ) = ωτ - ∠ H ( ω ) \qquad ( 15 )$$

From the above, the measurement apparatus 10 can calculate the phase error of the quadrature modulator 200, based on half of the phase of −N(−ω)/P(ω).

Correcting P(ω) of Expression 11 using the phase error calculated from Expression 15 leads to Expression 16 shown below.

P′(ω)=p(ω)=P(ω)·e^{j(ωτ-∠H(ω)))}=|H(ω)|·G·e^{jθω}^{_{c}} (16)

The amplitude in Expression 16, namely the absolute value of the amplitude vector, is |H(ω)|·G. Furthermore, the phase of Expression 16 is θω_{C}.

From the above, the measurement apparatus 10 can calculate the gain error of the quadrature modulator 200, based on the amplitude, specifically the absolute value of the amplitude vector, of P(ω) corrected according to the phase error. Furthermore, the measurement apparatus 10 can calculate the phase error of the quadrature modulator 200 based on the phase of P(ω) corrected according to the phase error.

Based on Expressions 11, 12, and 13, −N(−ω)·P(ω) is expressed as shown below in Expression 17.

$$- N ( - ω ) \cdot P ( ω ) = {\vert H ( ω ) \vert}^{2} \cdot {G}^{2} \cdot {e}^{{j2θ}_{{ω}_{c}}} \qquad ( 17 )$$

The square root of the amplitude of Expression 17, namely the absolute value of the amplitude vector, is |H(ω)|·G. Furthermore, one half of the phase of Expression 17 is θω_{C}.

From the above, the measurement apparatus 10 can calculate the gain error of the quadrature modulator 200, based on the square root of the amplitude, specifically the absolute value of the amplitude vector, of −N(−ω)·P(ω). Furthermore, the measurement apparatus 10 can calculate the carrier phase error of the quadrature modulator 200 based on half of the phase of −N(−ω)·P(ω).

Correcting P(ω) of Expression 11 according to the carrier phase error and the gain error calculated from Expression 17 leads to Expression 18 shown below.

P′(ω)=e^{-j(ωτ-∠H(ω))} (18)

The phase of Expression 18 is ωτ−∠H(ω). From the above, the measurement apparatus 10 can calculate the phase error of the quadrature modulator 200 based on the phase of P(ω) corrected according to the gain error and the carrier phase error.

Here, P(ω) of Expression 11 may be corrected according only to the carrier phase error calculated from Expression 17. In this case, Expression 11 is transformed into Expression 19 shown below.

P′(ω)=|H(ω)|·G·e^{-j(ωτ-∠H(ω))} (19)

The phase of Expression 19 is ωτ−∠H(ω). From the above, the measurement apparatus 10 can calculate the phase error of the quadrature modulator 200 based on the phase of P(ω) corrected according to at least the carrier phase error.

Based on Expressions 11, 12, and 13, −N(−ω)·P*(ω) is expressed as shown below in Expression 20. P*(ω) represents the complex conjugate of P(ω).

−N(−ω)·P*(ω)=|H(ω)|²·G²·e^{2j(ωτ-∠H(ω))} (20)

The square root of the amplitude of Expression 20, namely the absolute value of the amplitude vector, is |H(ω)|·G. Furthermore, one half of the phase of Expression 20 is ωτ−∠H(ω).

From the above, the measurement apparatus 10 can calculate the gain error of the quadrature modulator 200, based on the square root of the amplitude, specifically the absolute value of the amplitude vector, of −N(−ω)·P*(ω). Furthermore, the measurement apparatus 10 can calculate the phase error of the quadrature modulator 200 based on half of the phase of −N(−ω)·P*(ω).

Correcting P(ω) of Expression 11 according to the phase error and the gain error calculated from Expression 20 leads to Expression 21 shown below.

$${P}^{′} ( ω ) = {e}^{{jθ}_{{ω}_{c}}} \qquad ( 21 )$$

The phase of Expression 21 is θω_{C}. From the above, the measurement apparatus 10 can calculate the carrier phase error of the quadrature modulator 200 based on the phase of P(ω) corrected according to the gain error and the phase error.

P(ω) of Expression 11 may be corrected according to only the phase error calculated from Expression 20. In this case, Expression 11 is transformed into Expression 22 shown below.

$${P}^{′} ( ω ) = \vert H ( ω ) \vert \cdot G \cdot {e}^{{jθ}_{{ω}_{c}}} \qquad ( 22 )$$

The phase of Expression 22 is θω_{C}. From the above, the measurement apparatus 10 can calculate the carrier phase error of the quadrature modulator 200 based on the phase of P(ω) corrected according to at least the phase error.

The measurement apparatus 10 may calculate the phase error and gain error using Expression 20 and calculate the carrier phase error using Expression 17. The measurement apparatus 10 may calculate the gain error, the phase error, and the carrier phase error using a combination of the Expressions described above.

FIG. 5 shows exemplary frequency characteristics of the IQ error, in this case the gain error |Q/I| and the phase error ∠(Q/I), of the quadrature modulator 200.

As shown in FIG. 5, the frequency characteristic of the gain error |Q/I| is separated into gain G, which is a component that remains constant with respect to the frequency, and ripple |H(ω)|, which is a component that changes according to the frequency. Accordingly, when calculating the gain error, the measurement apparatus 10 preferably separates the component G that is constant with respect to the frequency and the ripple |H(ω)|.

Here, the gain G component that remains constant with respect to the frequency is expressed as a coefficient that is multiplied by the entire function representing the gain error. Accordingly, the measurement apparatus 10 can separate the constant component G and the ripple |H(ω)| by calculating the gain error for each of a plurality of angular frequencies in a multi-tone signal and estimating the function representing the gain error of the quadrature modulator 200.

As shown in FIG. 5, the frequency characteristic of the phase error ∠(Q/I) is divided into skew −ωτ, which changes linearly according to the frequency, and group delay ∠H(ω), which changes asymmetrically according to the frequency. Therefore, when calculating the phase error, the measurement apparatus 10 preferably separates the skew τ and the group delay ∠H(ω).

The skew τ represents a first-order term in the function expressing the phase error of the quadrature modulator 200. Accordingly, the measurement apparatus 10 can separate the skew τ and the group delay ∠H(ω) by calculating the phase error at each of a plurality of angular frequencies in a multi-tone signal and estimating the function expressing the phase error of the quadrature modulator 200.

If the equation representing H(ω) is predicted in advance, the measurement apparatus 10 can calculate the phase error, gain error, and carrier phase error using the following method instead of the method described above.

The phase of P(ω) is expressed as shown in Expression 23 below.

∠{P(ω)}=−(ωτ−∠H(ω))+θ_{ω}_{_{C}} (23)

When ω=0, τ and H(ω) are both 0 as well. In other words, when ω=0, ωτ−|H(ω)|=0. Accordingly, in the case of a DC frequency component, i.e. when ω=0, the measurement apparatus 10 can calculate the carrier phase error θω_{C} by calculating the phase of P(ω).

The measurement apparatus 10 can use the multi-tone signal to calculate the actual measured values of P(ω) for each of the plurality of angular frequencies. Next, the measurement apparatus 10 calculates a first-order function representing P(ω), by fitting a first-order equation with was the variable to the actual measured value of P(ω) for each of the angular frequencies. For example, the measurement apparatus 10 may calculate the first-order function that has the smallest error with respect to P(ω) by using the method of least squares.

The slope of the first-order function calculated in this manner represents the skew τ, and the intercept at ω=0 represents the carrier phase error. Accordingly, the measurement apparatus 10 can calculate the skew τ as the slope of the first-order function calculated in the above manner and can calculate the carrier phase error as the intercept at ω=0.

If the equation representing H(ω) is predicted in advance, the measurement apparatus 10 can calculate the function expressing P(ω) by fitting the this predicted equation to the actual measured values of P(ω) at each of the angular frequencies. For example, the measurement apparatus 10 may calculate the function that has the smallest error by using the method of least squares.

In the function calculated in this manner, the first-order coefficient represents the skew τ and the coefficients of other orders represent the group delay H(ω). Accordingly, the measurement apparatus 10 can calculate the skew τ as the coefficient of the first-order term in the function calculated in this way and calculate the group delay H(ω) as the coefficients of the terms other than the first-order term.

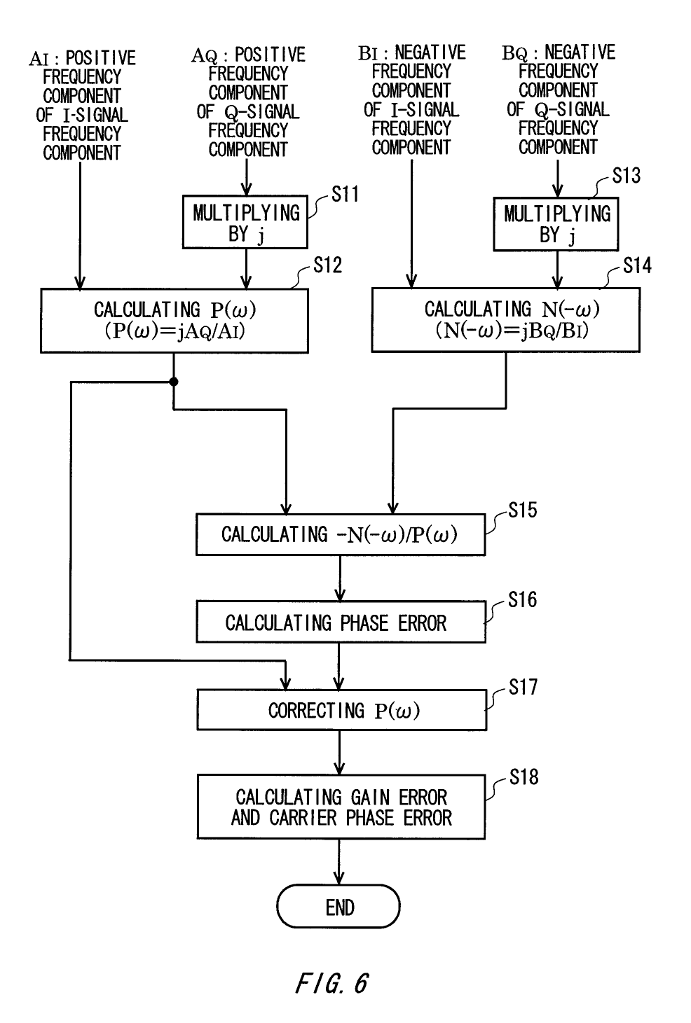

FIG. 6 shows a first exemplary process flow of the calculating section 22 according to the present embodiment. The calculating section 22 performs the process shown in FIG. 6 when calculating the phase error, gain error, or carrier phase error of the quadrature modulator 200, for example.

Prior to this process, the calculating section 22 receives from the extracting section 20 a positive frequency component A_{I} in the I-signal frequency component, a positive frequency component A_{Q} in the Q-signal frequency component, a negative frequency component B₁ in the I-signal frequency component, and a negative frequency component B_{Q} in the Q-signal frequency component.

Next, the calculating section 22 multiplies the positive frequency component A_{Q} in the Q-signal frequency component by an imaginary unit j (S11). The calculating section 22 calculates P(ω)=(jA_{Q}/A_{I}) by dividing j×A_{Q}, which is the product of the imaginary unit j and the positive frequency component A_{Q} in the Q-signal frequency component, by the positive frequency component A_{I} in the I-signal frequency component (S12).

The calculating section 22 multiplies the negative frequency component B_{Q} in the Q-signal frequency component by an imaginary unit j (S13). The calculating section 22 calculates N(−ω)=(jB_{Q}/B_{I}) by dividing j×B_{Q}, which is the product of the imaginary unit j and the negative frequency component B_{Q} in the Q-signal frequency component, by the negative frequency component B_{I} in the I-signal frequency component (S12).

Next, the calculating section 22 calculates −N(−ω)/P(ω) by dividing N(−ω) by P(ω) and inverting the sign of the result (S15). The calculating section 22 then calculates the phase error for each of one or more angular frequencies w at which a tone signal occurs (S16). Specifically, the calculating section 22 calculates the phase error to be half of the phase of −N(−ω)/P(ω).

Next, the calculating section 22 corrects P(ω) by multiplying the phase error calculated at step S16 by P(ω) calculated at step S12 (S17). As a result, the calculating section 22 can eliminate the effect of the phase error of the quadrature modulator 200 from P(ω).

Next, the calculating section 22 calculates the gain error and the carrier phase error for each of one or more angular frequencies w at which a tone signal occurs, based on the corrected P(ω) (S18). Specifically, the calculating section 22 calculates the gain error to be the amplitude of the corrected P(ω). The calculating section 22 calculates the carrier frequency error to be the phase of the corrected P(ω).

The calculating section 22 described above can accurately and easily measure the phase error, gain error, and carrier phase error of the quadrature modulator 200. Furthermore, the calculating section 22 can calculate the frequency characteristics of the gain error and the phase error by performing the above process for the angular frequency 0k of each tone signal in a multi-tone signal.

The calculating section 22 may separate the frequency characteristic of the gain error into a component that is constant with respect to the frequency and a ripple that changes according to the frequency. The calculating section 22 may separate the frequency characteristic of the phase error into a skew that is expressed as a first-order term of the frequency and a group delay that is expressed as the terms other than the first-order term of the frequency. As a result, the calculating section 22 can calculate the characteristics of the IQ error of the extracting section 20 in more detail.

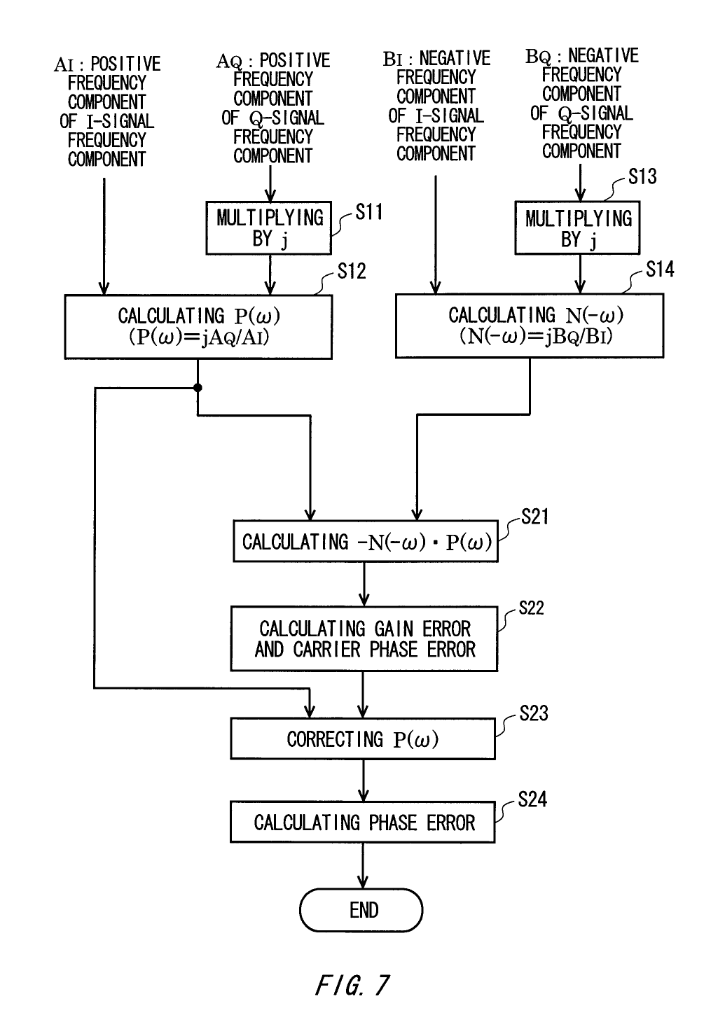

FIG. 7 shows a second exemplary process flow of the calculating section 22 according to the present embodiment. The calculating section 22 may perform the process shown in FIG. 7 instead of the process shown in FIG. 6 when calculating the phase error, gain error, or carrier phase error of the quadrature modulator 200.

First, the calculating section 22 performs the processes shown by steps S11 to S14 in FIG. 6. Next, the calculating section 22 calculates −N(−ω)·P(ω) by multiplying N(−ω) by P(ω) and inverting the sign of the result (S21).

The calculating section 22 then calculates the gain error and the carrier phase error for each of one or more angular frequencies w at which a tone signal occurs (S22). In other words, the calculating section 22 calculates the gain error to be the square root of the amplitude of −N(−ω)·P(ω). The calculating section 22 calculates the carrier phase error to be half of the phase of −N(−ω)·P(ω).

Next, the calculating section 22 corrects P(ω) by dividing the gain error and carrier phase error calculated at step S22 by P(ω) calculated at step S12 (S23). As a result, the calculating section 22 can eliminate the effect of the gain error and the carrier phase error of the quadrature modulator 200 from P(ω). In this case, the calculating section 22 may eliminate just the carrier phase error from P(ω).

Next, the calculating section 22 calculates the phase error for each of one or more angular frequencies w at which a tone signal occurs, based on the corrected P(ω) (S24). In other words, the calculating section 22 calculates the phase error to be the phase of the corrected P(ω).

In the manner described above, the calculating section 22 can accurately and easily measure the phase error, gain error, and carrier phase error of the quadrature modulator 200. Furthermore, the calculating section 22 can calculate the frequency characteristics of the gain error and the phase error by performing the above process for the angular frequency ωₖ of each tone signal in a multi-tone signal.

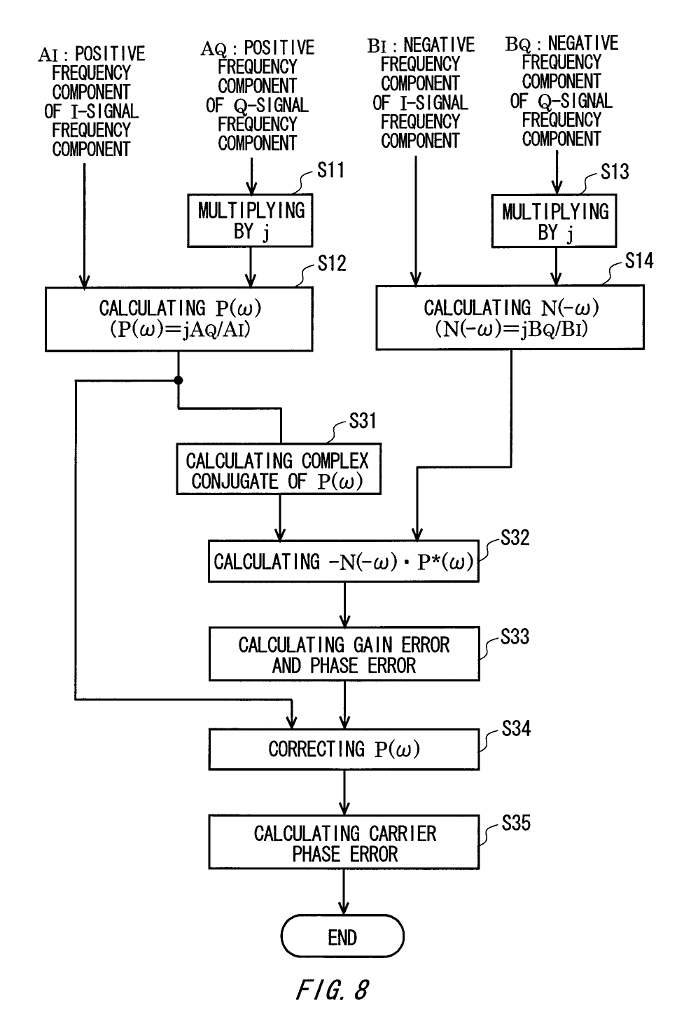

FIG. 8 shows a third exemplary process flow of the calculating section 22 according to the present embodiment. The calculating section 22 may perform the process shown in FIG. 8 instead of the process shown in FIG. 6 when calculating the phase error, gain error, or carrier phase error of the quadrature modulator 200.

First, the calculating section 22 performs the process shown by step S11 to S14 in FIG. 6. Next, the calculating section 22 calculates the complex conjugate P*(ω) of P(ω) calculated in step S12 (S31). The calculating section 22 then calculates −N(−ω)·P*(ω) by multiplying N(−ω) by P*(ω) and inverting the sign of the result (S32).

The calculating section 22 then calculates the gain error and the phase error for each of one or more angular frequencies w at which a tone signal occurs (S33). In other words, the calculating section 22 calculates the gain error to be the square root of the amplitude of −N(−ω)·P*(ω). The calculating section 22 calculates the phase error to be half of the phase of −N(−ω)·P*(ω).

Next, the calculating section 22 corrects P(ω) by dividing the gain error and the phase error calculated at step S33 by P(ω) calculated at step S12 (S34). As a result, the calculating section 22 can eliminate the effect of the gain error and the phase error of the quadrature modulator 200 from P(ω). In this case, the calculating section 22 may divide just the phase error by P(ω).

The calculating section 22 then calculates the carrier phase error for each of one or more angular frequencies w at which a tone signal occurs, based on the corrected P(ω) (S35). Specifically, the calculating section 22 calculates the carrier phase error to be the phase of the corrected P(ω).

In the manner described above, the calculating section 22 can accurately and easily measure the phase error, gain error, and carrier phase error of the quadrature modulator 200. Furthermore, the calculating section 22 can calculate the frequency characteristics of the gain error and the phase error by performing the above process for the angular frequency ωₖ of each tone signal in a multi-tone signal.

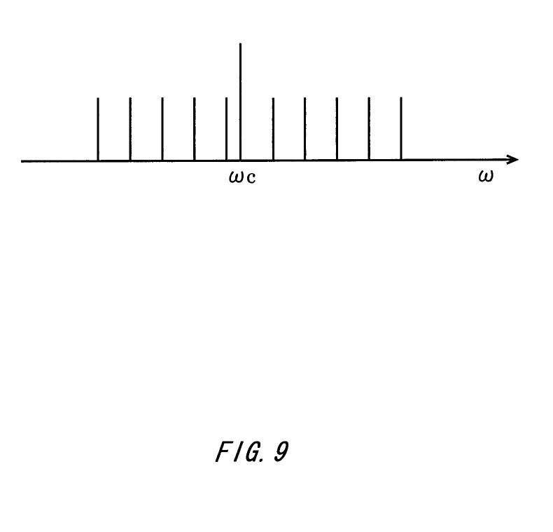

FIG. 9 shows an exemplary multi-tone signal output from an ideal quadrature modulator simultaneously supplied with a reference I signal and a reference Q signal. The supplying section 12 may supply the quadrature modulator 200 with a reference I signal and a reference Q signal corresponding to an IQ signal causing a multi-tone signal with both a positive frequency and a negative frequency.

In this case, the supplying section 12 shifts the reference I signal and/or the reference Q signal corresponding to the IQ signal causing the multi-tone signal such that the feedback components of these signals do not overlap, and supplies the resulting signals to the quadrature modulator 200. In this way, the measurement apparatus 10 can measure the frequency characteristics of the phase error and the gain error over a wider frequency band.

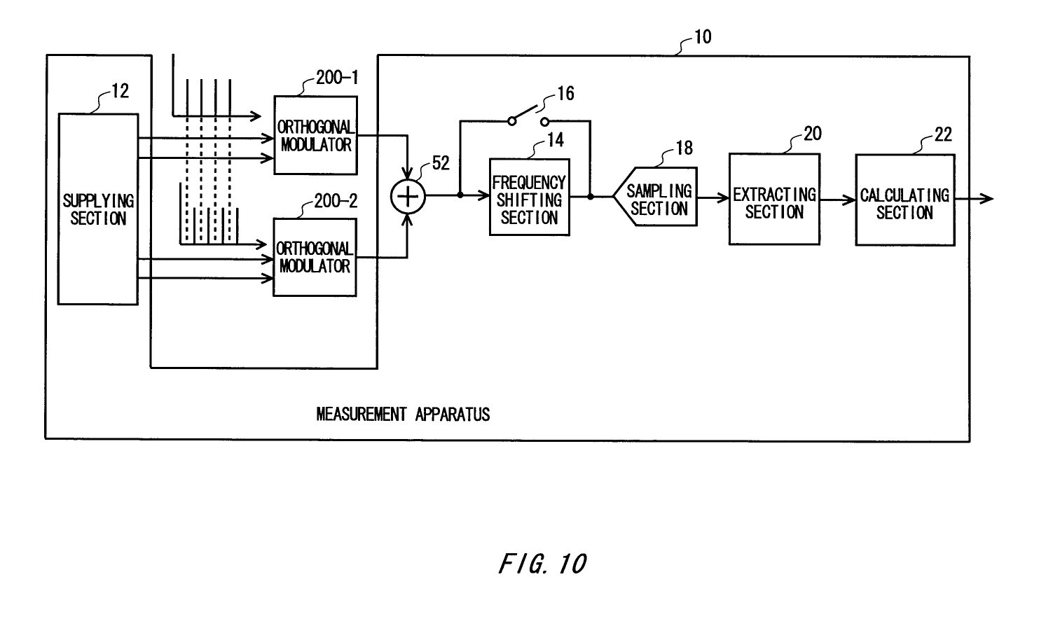

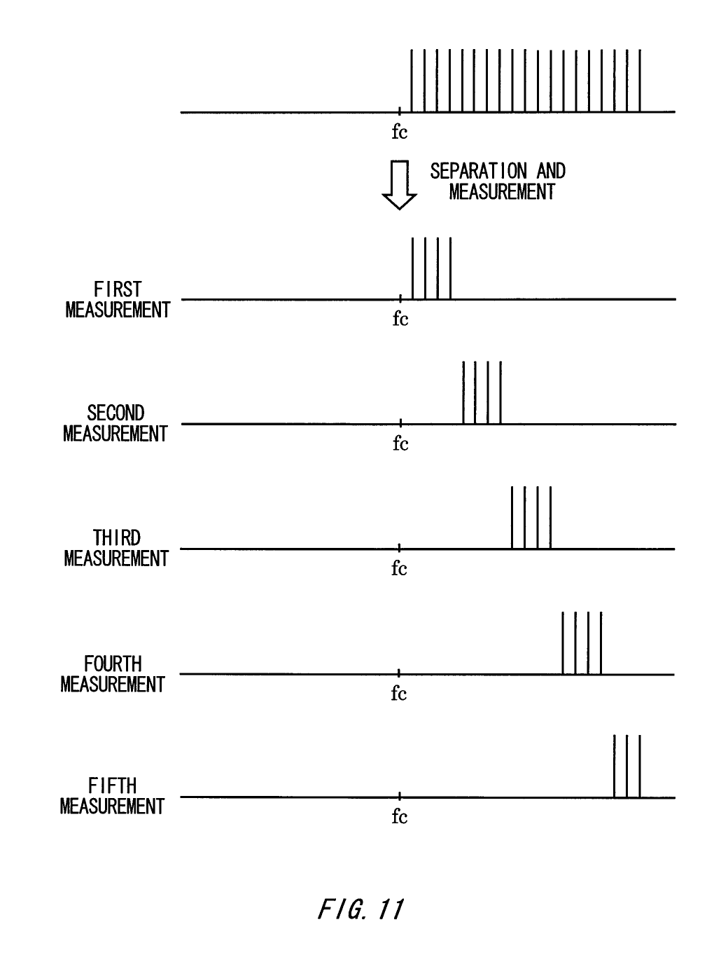

FIG. 10 shows a configuration of the measurement apparatus 10 according to a first modification of the present embodiment, along with the quadrature modulator 200. The measurement apparatus 10 of the first modification has substantially the same function and configuration as the measurement apparatus 10 shown in FIG. 1, and therefore components having substantially the same function are given the same reference numerals and further description is omitted.

The measurement apparatus 10 of the present modification measures at least one of the phase error and the gain error for each of a plurality of quadrature modulators 200. The measurement apparatus 10 of the present modification includes an adding section 52. The adding section 52 outputs a summed signal obtained by adding together the modulated signals output by a plurality of quadrature modulators 200.

In the present modification, the supplying section 12 supplies each quadrature modulator 200 in parallel with the reference I signal and reference Q signal shifted to have a time difference therebetween. For example, the supplying section 12 may supply the plurality of quadrature modulators 200 in parallel with the reference I signal, and then supply the plurality of quadrature modulators 200 in parallel with the reference Q signal. As another example, the supplying section 12 may supply the plurality of quadrature modulators 200 in parallel with the reference Q signal, and then supply the plurality of quadrature modulators 200 in parallel with the reference I signal.

In this case, the supplying section 12 provides the quadrature modulators 200 in parallel with reference I signals and reference Q signals corresponding to IQ signals causing multi-tone signals whose frequencies do not overlap. The extracting section 20 extracts frequency components corresponding to the tone signals for each quadrature modulator 200 from the summed signal output by the adding section 52.

The calculating section 22 receives the I-signal frequency components and the Q-signal frequency components corresponding to the tone signals included in the summed signal, for each quadrature modulator 200. The calculating section 22 then calculates at least one of the phase error and the gain error for each quadrature modulator 200, based on the corresponding I-signal frequency component and Q-signal frequency component.

In the manner described above, the measurement apparatus 10 according to the present modification can easily and accurately measure the IQ error for each of a plurality of quadrature modulators 200.

FIG. 11 shows an exemplary multi-tone signal output by an ideal quadrature modulator supplied with a reference I signal and a reference Q signal from the measurement apparatus 10 according to a second modification of the present embodiment. The measurement apparatus 10 according to the second modification has substantially the same function and configuration as the measurement apparatus 10 shown in FIG. 1, and therefore components having substantially the same function are given the same reference numerals and further description is omitted.

The measurement apparatus 10 of the present modification performs the following process when measuring at least one of the phase error and the gain error of the quadrature modulator 200 over a wide frequency range. In other words, the supplying section 12 of the measurement apparatus 10 divides the frequency range over which the phase error and gain error are measured into partial regions.

The supplying section 12 sequentially selects one partial region at a time, and performs the process to measure at least one of the phase error and the gain error for the selected partial region. In the process performed for each partial region, the supplying section 12 supplies the quadrature modulator 200 with the reference I signal and the reference Q signal corresponding to the IQ signal causing a multi-tone signal that covers the selected partial region. In this way, the measurement apparatus 10 can measure the frequency characteristics of the phase error and the gain error in the selected partial region.

The measurement apparatus 10 performs the above process for each of the selected partial regions. As a result, even when the frequency range that can be measured is narrow, the measurement apparatus 10 can measure at least one of the phase error and the gain error of the quadrature modulator 200 over a wide frequency range.

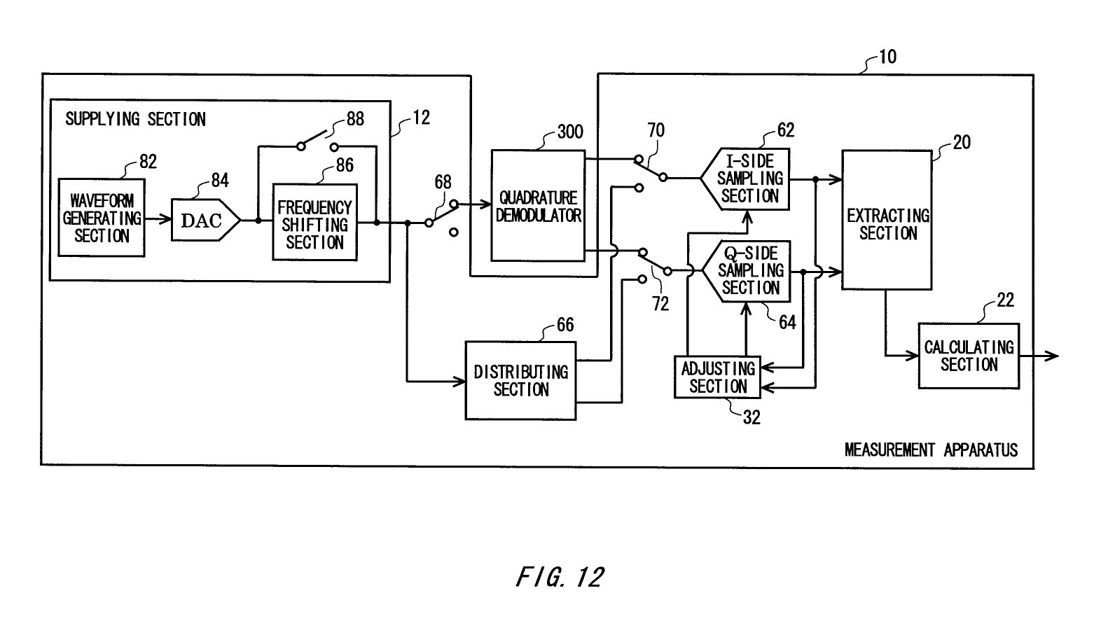

FIG. 12 shows an exemplary configuration of the measurement apparatus 10 according to a third modification of the present embodiment, along with a quadrature demodulator 300. The measurement apparatus 10 of the third modification has substantially the same function and configuration as the measurement apparatus 10 shown in FIG. 1, and therefore components having substantially the same function are given the same reference numerals and further description is omitted.

The measurement apparatus 10 of the present modification measures at least one of the phase error and the gain error between I and Q in the quadrature demodulator 300 instead of in the quadrature modulator 200. The measurement apparatus 10 of the present modification includes the supplying section 12, an I-side sampling section 62, a Q-side sampling section 64, the extracting section 20, the calculating section 22, a distributing section 66, an output switching section 68, an I-side input switching section 70, a Q-side input switching section 72, and an adjusting section 32.

The supplying section 12 shifts a first modulated signal corresponding to a signal obtained by orthogonally modulating the I component in an IQ signal causing a tone signal and/or a second modulated signal corresponding to a signal obtained by orthogonally modulating a Q component of the IQ signal to have a time difference therebetween, and supplies the resulting signals to the orthogonal demodulator 300. In other words, the supplying section 12 outputs, as the first modulated signal, the modulated signal output as a result of an ideal quadrature modulator orthogonally modulating the reference I signal output from the supplying section 12 described in FIG. 1. Furthermore, the supplying section 12 outputs, as the second modulated signal, the modulated signal output as a result of an ideal quadrature modulator orthogonally modulating the reference Q signal output from the supplying section 12 described in FIG. 1.

The supplying section 12 may shift the first modulated signal, which corresponds to a signal obtained by orthogonally modulating the I component of an IQ signal causing a multi-tone signal with either a positive frequency or a negative frequency, and the second modulated signal, which corresponds to a signal obtained by orthogonally modulating the Q component in this IQ signal, to have a time difference therebetween, and supply the resulting signals to the quadrature demodulator 300. Instead, the supplying section 12 may shift the first modulated signal, which corresponds to a signal obtained by orthogonally modulating the I component of an IQ signal causing a multi-tone signal in which the feedback components do not overlap, and the second modulated signal, which corresponds to a signal obtained by orthogonally modulating the Q component in this IQ signal, to have a time difference therebetween, and supply the resulting signals to the quadrature demodulator 300.

The supplying section 12 may include a waveform generating section 82, a DAC 84, a frequency shifting section 86, and a bypass switch 88. The waveform generating section 82 shifts the waveform data of the first modulated signal and/or the waveform data of the second modulated signal to have a time difference therebetween. The DAC 84 performs DA conversion on the waveform data supplied from the waveform generating section 82, and outputs the resulting first modulated signal and second modulated signal.

The frequency shifting section 86 up-converts the carrier frequencies of the first modulated signal and the second modulated signal output from the supplying section 12, and supplies the resulting signals to the quadrature demodulator 300. If the up-conversion by the frequency shifting section 86 is unnecessary, the bypass switch 88 may cause the first modulated signal and the second modulated signal output by the DAC 84 to bypass the frequency shifting section 86 and be supplied to the quadrature demodulator 300.

As described above, the supplying section 12 can shift the first modulated signal and/or the second modulated signal to have a time difference therebetween, and supply the resulting signals to the quadrature demodulator 300. The quadrature demodulator 300 can output a baseband signal obtained by orthogonally demodulating the first modulated signal. The extracting section 20 can output a baseband signal obtained by orthogonally demodulating the second modulated signal.

The I-side sampling section 62 samples and digitizes the signal corresponding to the I component in the baseband signal output from the quadrature demodulator 300. The Q-side sampling section 64 samples and digitizes the signal corresponding to the Q component in the baseband signal output from the quadrature demodulator 300.

The extracting section 20 extracts the frequency component corresponding to the tone signal included in the baseband signal obtained by the quadrature demodulator 300 demodulating the first modulated signal. The extracting section 20 also extracts the frequency component corresponding to the tone signal included in the baseband signal obtained by the quadrature demodulator 300 demodulating the second modulated signal.

The calculating section 22 calculates at least one of the phase error and the gain error of the quadrature demodulator 300 based on the frequency component corresponding to the tone signal in the baseband signal resulting from the demodulation of the first modulated signal and the frequency component corresponding to the tone signal in the baseband signal resulting from the demodulation of the second modulated signal. The calculating section 22 may also calculate the carrier phase error of the quadrature demodulator 300.

Here, the calculating section 22 treats the frequency component corresponding to the tone signal in the baseband signal resulting from the demodulation of the first modulated signal as the Q-signal frequency component. Furthermore, the calculating section 22 treats the frequency component corresponding to the tone signal in the baseband signal resulting from the demodulation of the second modulated signal as the Q-signal frequency component. The calculating section 22 calculates the phase error, gain error, and carrier phase error in the same manner as the calculating section 22 described in relation to FIG. 1.

As a result, the measurement apparatus 10 of the present modification can easily and accurately calculate the phase error, gain error, and carrier phase error of the quadrature demodulator 300.

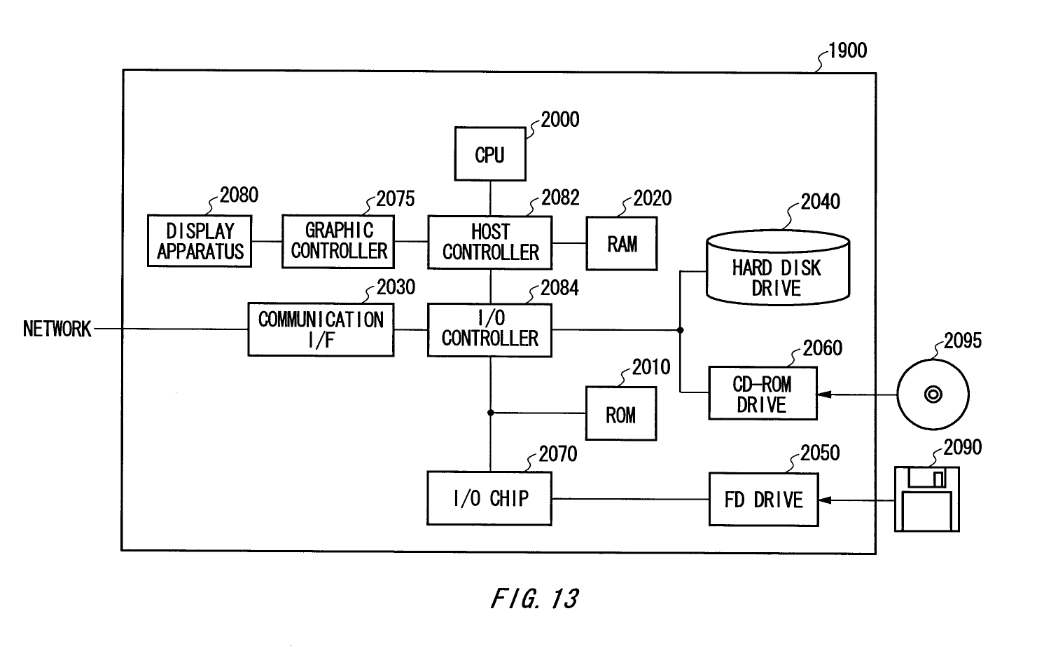

FIG. 13 shows an example of a hardware configuration of a computer 1900 according to the present embodiment. The computer 1900 according to the present embodiment is provided with a CPU peripheral including a CPU 2000, a RAM 2020, a graphic controller 2075, and a display apparatus 2080, all of which are connected to each other by a host controller 2082; an input/output section including a communication interface 2030, a hard disk drive 2040, and a CD-ROM drive 2060, all of which are connected to the host controller 2082 by an input/output controller 2084; and a legacy input/output section including a ROM 2010, a flexible disk drive 2050, and an input/output chip 2070, all of which are connected to the input/output controller 2084.

The host controller 2082 is connected to the RAM 2020 and is also connected to the CPU 2000 and graphic controller 2075 accessing the RAM 2020 at a high transfer rate. The CPU 2000 operates to control each section based on programs stored in the ROM 2010 and the RAM 2020. The graphic controller 2075 acquires image data generated by the CPU 2000 or the like on a frame buffer disposed inside the RAM 2020 and displays the image data in the display apparatus 2080. In addition, the graphic controller 2075 may internally include the frame buffer storing the image data generated by the CPU 2000 or the like.

The input/output controller 2084 connects the communication interface 2030 serving as a relatively high speed input/output apparatus, and the hard disk drive 2040, and the CD-ROM drive 2060 to the host controller 2082. The communication interface 2030 communicates with other apparatuses via a network. The hard disk drive 2040 stores the programs and data used by the CPU 2000 housed in the computer 1900. The CD-ROM drive 2060 reads the programs and data from a CD-ROM 2095 and provides the read information to the hard disk drive 2040 via the RAM 2020.

Furthermore, the input/output controller 2084 is connected to the ROM 2010, and is also connected to the flexible disk drive 2050 and the input/output chip 2070 serving as a relatively high speed input/output apparatus. The ROM 2010 stores a boot program performed when the computer 1900 starts up, a program relying on the hardware of the computer 1900, and the like. The flexible disk drive 2050 reads programs or data from a flexible disk 2090 and supplies the read information to the hard disk drive 2040 via the RAM 2020. The input/output chip 2070 connects the flexible disk drive 2050 to the input/output controller 2084 along with each of the input/output apparatuses via, a parallel port, a serial port, a keyboard port, a mouse port, or the like.

The programs provided to the hard disk drive 2040 via the RAM 2020 are stored in a storage medium, such as the flexible disk 2090, the CD-ROM 2095, or an IC card, and provided by a user. The programs are read from storage medium, installed in the hard disk drive 2040 inside the computer 1900 via the RAM 2020, and performed by the CPU 2000.

The programs installed in the computer 1900 make the computer 1900 function as the extracting section 20 and the calculating section 22 of the measurement apparatus 10, and include an extraction module and a calculation module. These programs and modules prompt the CPU 2000 or the like to make the computer 1900 function as the extracting section 20 and the calculating section 22.

The information processes recorded in these programs are read by the computer 1900 to cause the computer 1900 to function as software and hardware described above, which are exemplified by the specific means of the extracting section 20 and the calculating section 22. With these specific means, a unique measurement apparatus 10 suitable for an intended use and including the extracting section 20 and the calculating section 22 can be configured by realizing the calculations or computations appropriate for the intended use of the computer 1900 of the present embodiment.

For example, if there is communication between the computer 1900 and an external apparatus or the like, the CPU 2000 performs the communication program loaded in the RAM 2020, and provides the communication interface 2030 with communication processing instructions based on the content of the process recorded in the communication program. The communication interface 2030 is controlled by the CPU 2000 to read the transmission data stored in the transmission buffer area or the like on the storage apparatus, such as the RAM 2020, the hard disk drive 2040, the flexible disk 2090, or the CD-ROM 2095, and send this transmission data to the network, and to write data received from the network onto a reception buffer area on the storage apparatus. In this way, the communication interface 2030 may transmit data to and from the storage apparatus through DMA (Direct Memory Access). As another possibility, the CPU 2000 may transmit the data by reading the data from the storage apparatus or communication interface 2030 that are the origins of the transmitted data, and writing the data onto the communication interface 2030 or the storage apparatus that are the transmission destinations.

The CPU 2000 may perform various processes on the data in the RAM 2020 by reading into the RAM 2020, through DMA transmission or the like, all or a necessary portion of the database or files stored in the external apparatus such as the hard disk drive 2040, the CD-ROM drive 2060, the CD-ROM 2095, the flexible disk drive 2050, or the flexible disk 2090. The CPU 2000 writes the processed data back to the external apparatus through DMA transmission or the like. In this process, the RAM 2020 is considered to be a section that temporarily stores the content of the external storage apparatus, and therefore the RAM 2020, the external apparatus, and the like in the present embodiment are referred to as a memory, a storage section, and a storage apparatus. The variety of information in the present embodiment, such as the variety of programs, data, tables, databases, and the like are stored on the storage apparatus to become the target of the information processing. The CPU 2000 can hold a portion of the RAM 2020 in a cache memory and read from or write to the cache memory. With such a configuration as well, the cache memory serves part of the function of the RAM 2020, and therefore the cache memory is also included with the RAM 2020, the memory, and/or the storage apparatus in the present invention, except when a distinction is made.

The CPU 2000 executes the various processes such as the computation, information processing, condition judgment, searching for/replacing information, and the like included in the present embodiment for the data read from the RAM 2020, as designated by the command sequence of the program, and writes the result back onto the RAM 2020. For example, when performing condition judgment, the CPU 2000 judges whether a variable of any type shown in the present embodiment fulfills a condition of being greater than, less than, no greater than, no less than, or equal to another variable or constant. If the condition is fulfilled, or unfulfilled, depending on the circumstances, the CPU 2000 branches into a different command sequence or acquires a subroutine.

The CPU 2000 can search for information stored in a file in the storage apparatus, the database, and the like. For example, if a plurality of entries associated respectively with a first type of value and a second type of value are stored in the storage apparatus, the CPU 2000 can search for entries fulfilling a condition designated by the first type of value from among the plurality of entries stored in the storage apparatus. The CPU 2000 can then obtain the second type of value associated with the first type of value fulfilling the prescribed condition by reading the second type of value stored at the same entry.

The programs and modules shown above may also be stored in an external storage medium. The flexible disk 2090, the CD-ROM 2095, an optical storage medium such as a DVD or CD, a magneto-optical storage medium, a tape medium, a semiconductor memory such as an IC card, or the like can be used as the storage medium. Furthermore, a storage apparatus such as a hard disk or RAM that is provided with a server system connected to the Internet or a specialized communication network may be used to provide the programs to the computer 1900 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A measurement apparatus that measures at least one of phase error and gain error between I and Q of a quadrature modulator, the measurement apparatus comprising:
a supplying section that shifts a reference I signal corresponding to an I component in an IQ signal causing a tone signal and/or a reference Q signal corresponding to a Q component in the IQ signal to have a time difference therebetween, and supplies the resulting signals to the quadrature modulator; and
a calculating section that calculates at least one of the phase error and the gain error, based on an I-signal frequency component corresponding to a tone signal in a modulated signal output from the quadrature modulator in response to the reference I signal being supplied thereto and a Q-signal frequency component corresponding to a tone signal in a modulated signal output from the quadrature modulator in response to the reference Q signal being supplied thereto.

2. The measurement apparatus according to claim 1, wherein
the calculating section calculates at least one of a frequency characteristic of the phase error and a frequency characteristic of the gain error, based on the I-signal frequency component and the Q-signal frequency component corresponding to each of a plurality of tone signals with a plurality of frequencies.

3. The measurement apparatus according to claim 1, wherein
the supplying section shifts a reference I signal and/or a reference Q signal corresponding to an IQ signal causing a multi-tone signal with either a positive frequency or a negative frequency to have a time difference therebetween, and supplies the resulting signals to the quadrature modulator.

4. The measurement apparatus according to claim 3, wherein
the supplying section shifts a reference I signal and/or a reference Q signal corresponding to an IQ signal causing a multi-tone signal in which feedback components do not overlap to have a time difference therebetween, and supplies the resulting signals to the quadrature modulator.

5. The measurement apparatus according to claim 1, wherein
the calculating section calculates at least one of the phase error and the gain error, based on at least one of (i) a ratio between a positive frequency component in the I-signal frequency component and a positive frequency component in the Q-signal frequency component and (ii) a ratio between a negative frequency component in the I-signal frequency component and a negative frequency component in the Q-signal frequency component.

6. The measurement apparatus according to claim 5, wherein
with P(ω) representing a ratio of the positive frequency component in the Q-signal frequency component to the positive frequency component in the I-signal frequency component and N(−ω) representing a ratio of the negative frequency component in the Q-signal frequency component to the negative frequency component in the I-signal frequency component, the calculating section calculates the phase error to be half of a phase of −N(−ω)/P(ω).

7. The measurement apparatus according to claim 6, wherein
the calculating section corrects P(ω) according to the phase error, and calculates the gain error to be an amplitude of the corrected P(ω).

8. The measurement apparatus according to claim 6, wherein
the calculating section corrects P(ω) according to the phase error, and calculates the carrier phase error to be a phase of the corrected P(ω).

9. The measurement apparatus according to claim 5, wherein
with P(ω) representing a ratio of the positive frequency component in the Q-signal frequency component to the positive frequency component in the I-signal frequency component and N(−ω) representing a ratio of the negative frequency component in the Q-signal frequency component to the negative frequency component in the I-signal frequency component, the calculating section calculates the gain error to be the square root of an amplitude of −N(−ω)·P(ω).

10. The measurement apparatus according to claim 5, wherein
with P(ω) representing a ratio of the positive frequency component in the Q-signal frequency component to the positive frequency component in the I-signal frequency component and N(−ω) representing a ratio of the negative frequency component in the Q-signal frequency component to the negative frequency component in the I-signal frequency component, the calculating section calculates the carrier phase error to be half of a phase of −N(−ω)·P(ω).

11. The measurement apparatus according to claim 10, wherein
the calculating section corrects P(ω) according to at least the carrier phase error, and calculates the phase error to be a phase of the corrected P(ω).

12. The measurement apparatus according to claim 5, wherein
the calculating section calculates the ratio between the positive frequency component in the I-signal frequency component and the positive frequency component in the Q-signal frequency component for each of a plurality of frequencies, calculates a function representing a frequency characteristic of the ratio based on a predetermined equation for calculating the frequency characteristic of the ratio and the ratio calculated for each of the frequencies, and calculates at least one of the gain error and the phase error at a predetermined frequency based on the calculated function.

13. The measurement apparatus according to claim 1, wherein
the supplying section creates a predetermined guard period between the reference I signal and the reference Q signal.

14. The measurement apparatus according to claim 1, wherein
the measurement apparatus measures at least one of the phase error and the gain error for each of a plurality of the quadrature modulators,
the measurement apparatus further comprises an adding section that outputs a summed signal obtained by adding together modulated signals output by the quadrature modulators,
the supplying section supplies each quadrature modulator in parallel with a reference I signal and a reference Q signal corresponding to an IQ signal causing a tone signal, and frequencies of the tone signals do not overlap, and
the calculating section calculates at least one of the phase error and the gain error for each quadrature modulator, based on I-signal frequency components and Q-signal frequency components corresponding to tone signals in the summed signal.

15. The measurement apparatus according to claim 1, wherein
the supplying section sequentially selects partial regions obtained by dividing a frequency range over which the phase error and the gain error are measured, and repeatedly performs the process of shifting a reference I signal and/or a reference Q signal, corresponding to an IQ signal causing a multi-tone signal in the selected partial region, to have a time difference therebetween and supplying the resulting signals to the quadrature modulator.

16. A measurement method for measuring at least one of phase error and gain error between I and Q of a quadrature modulator, the measurement method comprising:
shifting a reference I signal corresponding to an I component in an IQ signal causing a tone signal and/or a reference Q signal corresponding to a Q component in the IQ signal to have a time difference therebetween, and supplying the resulting signals to the quadrature modulator; and
calculating at least one of the phase error and the gain error, based on an I-signal frequency component corresponding to the tone signal in a modulated signal output from the quadrature modulator in response to the reference I signal being supplied thereto and a Q-signal frequency component corresponding to the tone signal in a modulated signal output from the quadrature modulator in response to the reference Q signal being supplied thereto.

17. A recording medium storing thereon a program that causes a computer to function as the calculating section of the measurement apparatus according to claim 1.

18. A measurement apparatus that measures at least one of phase error and gain error between I and Q of a quadrature demodulator, the measurement apparatus comprising:
a supplying section that shifts a first modulated signal corresponding to a signal obtained by orthogonally modulating an I component in an IQ signal causing a tone signal and/or a second modulated signal corresponding to a signal obtained by orthogonally modulating a Q component in the IQ signal to have a time difference therebetween, and supplies the resulting signals to the quadrature demodulator; and
a calculating section that calculates at least one of the phase error and the gain error, based on a baseband signal obtained as a result of the quadrature demodulator demodulating the first modulated signal and a baseband signal obtained as a result of the quadrature demodulator demodulating the second modulated signal.

19. The measurement apparatus according to claim 18, wherein
the supplying section shifts a first modulated signal obtained by orthogonally modulating an I component in an IQ signal causing a multi-tone signal in either a positive frequency or a negative frequency and a second modulated signal obtained by orthogonally modulating a Q component in the IQ signal to have a time difference therebetween, and supplies the resulting signals to the quadrature demodulator.

20. The measurement apparatus according to claim 19, wherein
the supplying section shifts a first modulated signal obtained by orthogonally modulating an I component in an IQ signal causing a multi-tone signal in which feedback components do not overlap and a second modulated signal obtained by orthogonally modulating a Q component in the IQ signal to have a time difference therebetween, and supplies the resulting signals to the quadrature demodulator.

21. The measurement apparatus according to claim 18, wherein
the calculating section calculates at least one of the phase error and the gain error, based on at least one of (i) a ratio between a positive frequency component of a baseband signal obtained by demodulating the first baseband signal and a positive frequency component of a baseband signal obtained by demodulating the second baseband signal and (ii) a ratio between a negative frequency component of a baseband signal obtained by demodulating the first modulated signal and a negative frequency component of a baseband signal obtained by demodulating the second modulated signal.

22. A measurement method for measuring at least one of phase error and gain error between I and Q of a quadrature demodulator, the measurement method comprising:
shifting a first modulated signal corresponding to a signal obtained by orthogonally modulating an I component in an IQ signal causing a tone signal and a second modulated signal corresponding to a signal obtained by orthogonally modulating a Q component in the IQ signal to have a time difference therebetween, and supplying the resulting signals to the quadrature demodulator; and
calculating at least one of the phase error and the gain error, based on a baseband signal obtained as a result of the quadrature demodulator demodulating the first modulated signal and a baseband signal obtained as a result of the quadrature demodulator demodulating the second modulated signal.

23. A recording medium storing thereon a program that causes a computer to function as the calculating section of the measurement apparatus according to claim 18.
